(19) United States
(12) Patent Application Publication
(10) Pub. No.: US 2026/0030532 A1
(43) Pub. Date: Jan. 29, 2026

(54) METHODS FOR SYNTHESIZING BOOLEAN CIRCUITS FOR A QUANTUM ERROR CORRECTION DECODER AND A QUANTUM ERROR CORRECTION DECODER CHIP USING THEREOF

(71) Applicant: 1QB Information Technologies Inc., North Vancouver (CA)

(72) Inventors: Bohdan KULCHYTSKYY, Waterloo (CA); Miles Xavian KRAMER, Vancouver (CA); Gebremedhin Asrat DAGNEW, Waterloo (CA); Ali SARAERTOOSI, Waterloo (CA); Pooya RONAGH, Guelph (CA)

(21) Appl. No.: 19/343,362

(22) Filed: Sep. 29, 2025

Related U.S. Application Data
(63) Continuation of application No. PCT/IB2024/053046, filed on Mar. 28, 2024.
(60) Provisional application No. 63/493,648, filed on Mar. 31, 2023.

(51) Int. Cl. G06N 10/20; G06N 10/70

(52) U.S. Cl. CPC G06N 10/20; G06N 10/70

(57) ABSTRACT

A method for synthesizing Boolean circuits for an error correction decoder. The method may include: providing one or more input binary variables derived from one or more syndrome measurements; providing a mapping representative of a quantum error correction decoder; for said one or more input binary variables providing corresponding output binary variables representative of one or more recovery operations for qubits, wherein said output binary variables are generated using said mapping; and using said one or more input binary variables and said corresponding output binary variables to synthesize at least one Boolean circuit. A quantum error correction decoder chip comprising one or more Boolean circuits.

### CROSS-REFERENCE

This application is a continuation of International Application No. PCT/IB2024/053046 filed Mar. 28, 2024, which claims the benefit of U.S. Provisional Application No. 63/493,648, filed Mar. 31, 2023, each of which is incorporated herein by reference in its entirety.

### BACKGROUND

In digital computing and transmission of digital signals or data in communication systems, transmitted digital data may be subject to errors during transmission from a sender to a receiver. An error correction code or error correcting code (ECC) may be used to encode digital data to be transmitted for controlling errors in data over a communication channel from the sender to the receiver. The sender encodes the message or data to be transmitted with redundant information so that errors that may occur in the transmission can be detected and corrected without retransmission.

In quantum computing, a quantum system for performing quantum computations can be implemented by an ensemble of subsystems exhibiting different quantum states where subsystems are correlated or “entangled” with one another due to quantum coherence. In various implementations, each subsystem in the ensemble of subsystems may exhibit two or more different quantum states to operate as a fundamental quantum device. Information can be represented, stored, processed, and transmitted by superposition and correlation of quantum states of different fundamental quantum devices. Such a fundamental quantum device with two or more different quantum states may be referred to as a “qudit” and a two-state device is often to as a quantum bit (“qubit”). To realize practical applications of quantum computers, there is a need to create logical qubits and quantum gates whose error rates are suitably low. One path towards achieving these low error rates is through quantum error correction, which is a method for creating logical qubits and quantum gates which are more reliable than their physical component parts. However, quantum error correction may induce an overhead cost in terms of computational time and physical resources.

### SUMMARY

The present disclosure provides methods and systems for synthesizing Boolean circuits for an error correction decoder. The present disclosure provides a quantum error correction decoder chip comprising the synthesized Boolean circuits.

In quantum computing, in addition to errors which may occur during data transmission in the digital computing, quantum information is vulnerable to errors due to quantum decoherence and other quantum noise or interference. Quantum error correction may be useful to achieve fault tolerant quantum computing.

An advantage of the methods and systems disclosed herein is that the generated decoder architectures demand comparatively straightforward information processing. This attribute proves advantageous when implemented on hardware using CMOS, SFQ ASIC, or FPGA technologies, offering benefits such as a minimized hardware footprint, reduced power consumption, and heightened execution frequency.

Another advantage of the methods and systems disclosed herein is that this architectural design aligns seamlessly with Single-Instruction-Multiple-Data (SIMD) parallelization, making it well-suited for integration into GPU/CPU chips.

Another advantage of the methods and systems provided herein is that the quantum error correction decoder chip comprising synthesized Boolean circuits may be co-located with a quantum processor at the same cryogenic temperature, avoiding otherwise high communication costs.

In an aspect, the present disclosure provides a method for synthesizing Boolean circuits for a quantum error correction decoder. The method may comprise: (a) providing one or more input binary variables derived at least in part from one or more syndrome measurements; (b) providing a mapping representative of said quantum error correction decoder; (c) generating, based at least in part on said mapping, corresponding output binary variables for said one or more input binary variables, wherein said output binary variables are representative of one or more recovery operations for a plurality of qubits; and (d) synthesizing at least one Boolean circuit based at least in part on said one or more input binary variables and said corresponding output binary variables.

In some embodiments, (d) comprises constructing a look up table of said mapping based at least in part on said one or more input binary variables and said corresponding output binary variables. In some embodiments, (d) comprises performing an optimization on said Boolean circuit to reduce a number of logical gates of said Boolean circuit. In some embodiments, said optimization is performed iteratively and until a stopping criterion is reached. In some embodiments, said optimization comprises a two-level logic optimization. In some embodiments, said optimization comprises a multi-level logic optimization. In some embodiments, said two-level logic optimization comprises reducing a number of AND and OR gates. In some embodiments, said two-level logic optimization comprises reducing a number of AND, OR, and NOT gates.

In some embodiments, (d) further comprises converting said Boolean circuit into a netlist. In some embodiments, said netlist comprises a directed graph, wherein said directed graph is configured to define a flow and a sequence of logical gates of said Boolean circuit and one or more non-Boolean circuit elements. In some embodiments, said one or more recovery operations are for logical qubits or for physical qubits. In some embodiments, the method further comprises implementing said one or more recovery operations on said logical qubits or said physical qubits.

In some embodiments, said mapping in (b) is based at least in part on a recurrent neural network (RNN). In some embodiments, (b) comprises: (i) constructing a Deterministic Finite Automaton (DFA) of said RNN; and (ii) constructing one or more look up tables based at least in part on a classifier, wherein said classifier is configured to associate a label with each state of said DFA and wherein said classifier comprises a transition function configured to associate each state of said DFA to an input of a state of said DFA. In some embodiments, said RNN comprises a clustering layer for reducing DFA size. In some embodiments, said constructing of said DFA in (i) comprises implementing a merging procedure in the space of hidden states of said RNN, and said merging procedure is configured to reduce the complexity of said DFA. In some embodiments, the method further comprises reducing said DFA complexity based at least in part on a Hopcroft algorithm. In some embodiments, the method further comprises constructing a binary state encoding of said DFA. In some embodiments, (d) further comprises converting said Boolean circuit into a netlist and optimizing said netlist at least in part by relabeling said DFA.

In some embodiments, said one or more syndrome measurements are from a quantum error correction code comprising one or more members selected from the group consisting of: a Surface code, a colour code, a toric code, and a Bacon-Shor code. In some embodiments, the method further comprises, prior to (a), implementing a quantum error correction code. In some embodiments, the quantum error correction code comprises one or more members selected from the group consisting of: a Surface code, a colour code, a toric code, and a Bacon-Shor code. In some embodiments, said quantum error correction decoder comprises one or more members selected from the group consisting of: a Minimum-Weight Perfect Matching decoder, a Union Find decoder, a Belief Matching decoder, a Tensor-Network decoder, and a renormalization group decoder.

In another aspect, the present disclosure provides a quantum error correction decoder chip. The chip may comprise: one or more Boolean circuits, wherein said one or more Boolean circuits are configured to receive one or more input binary variables derived from one or more syndrome measurements from syndrome qubits, wherein said one or more Boolean circuits are configured to process said one or more input binary variables to generate output binary variables, and wherein said output binary variables are operable to generate one or more recovery operations.

In some embodiments, said one or more Boolean circuits comprise at least one member of the group consisting of: a field programmable gate array (FPGA), an ASIC, a CMOS, and an SFQ. In some embodiments, said chip is communicatively coupled to a quantum processor, wherein said quantum processor is operably coupled to and cooled by a cryogenic device at a cryogenic temperature, wherein said cryogenic device has different cryogenic stages at different cryogenic temperatures; and wherein said one or more Boolean circuits are operably coupled to and cooled by said cryogenic device at a different cryogenic stage. In some embodiments, said one or more Boolean circuits are operably coupled to a circuit cooled by said cryogenic device. In some embodiments, said one or more Boolean circuits are operably coupled to a circuit at room temperature. In some embodiments, said chip is communicatively coupled to a controller.

In some embodiments, said recovery operation comprises updating a Pauli frame or updating data qubits to reduce errors in quantum computing. In some embodiments, said quantum processor comprises one or more members selected from the group consisting of: a superconducting quantum processor, a semiconductor quantum processor, a trapped ion quantum processor, and a neutral atoms quantum processor. In some embodiments, one or more Boolean circuits are based at least in part on a look up table, wherein said look up table is based at least in part on said one or more input binary variables and said corresponding output binary variables.

In some embodiments, said one or more Boolean circuit are generated at least in part by performing an optimization on said one or more Boolean circuits to reduce a number of logical gates of said one or more Boolean circuits.

In some embodiments, said optimization is performed iteratively and until a stopping criterion is reached. In some embodiments, said optimization comprises a two-level logic optimization. In some embodiments, said optimization comprises a multi-level logic optimization. In some embodiments, said two-level logic optimization comprises reducing a number of AND and OR gates. In some embodiments, said two-level logic optimization comprises reducing a number of AND, OR, and NOT gates.

In some embodiments, said one or more Boolean circuits comprises a corresponding netlist. In some embodiments, said netlist comprises a directed graph, and said directed graph is configured to define a flow and a sequence of logical gates of said Boolean circuit and one or more non-Boolean circuit elements. In some embodiments, said one or more Boolean circuits is configured to provide said one or more recovery operations to be implemented on logical qubits or physical qubits of said quantum processor.

In some embodiments, said one or more Boolean circuits are generated based at least in part on a recurrent neural network (RNN). In some embodiments, said RNN comprises a clustering layer for reducing a Deterministic Finite Automaton (DFA) size.

In some embodiments, said one or more syndrome measurements are from a quantum error correction code comprising one or more members selected from the group consisting of: a Surface code, a colour code, a toric code, and a Bacon-Shor code. In some embodiments, the chip further comprises a quantum error correction code associated with said chip. In some embodiments, the quantum error correction code comprises one or more members selected from the group consisting of: a Surface code, a colour code, a toric code, and a Bacon-Shor code. In some embodiments, said chip is configured to implement a quantum error correction decoder. In some embodiments, said one or more recovery operations are configured to update one or more data qubits to reduce an error in a quantum computation. In some embodiments, said quantum error correction decoder comprises one or more members selected from the group consisting of: a Minimum-Weight Perfect Matching decoder, a Union Find decoder, a Belief Matching decoder, a Tensor-Network decoder, and a renormalization group decoder.

In another aspect, the present disclosure provides a processor communicatively coupled to a quantum computer, wherein said processor is configured to implement a set of instructions to: (a) provide one or more input binary variables derived at least in part from one or more syndrome measurements from said quantum computer; (b) provide a mapping representative of a quantum error correction decoder; (c) generate, based at least in part on said mapping, corresponding output binary variables for said one or more input binary variables, wherein said output binary variables are representative of one or more recovery operations for a plurality of qubits; and (d) synthesize at least one Boolean circuit based at least in part on said one or more input binary variables and said corresponding output binary variables.

In some embodiments, at (d) said processor is configured to construct a look up table of said mapping based at least in part on said one or more input binary variables and said corresponding output binary variables. In some embodiments, at (d) said processor is configured to perform an optimization on said Boolean circuit to reduce a number of logical gates of said Boolean circuit. In some embodiments, said optimization is performed iteratively and until a stopping criterion is reached. In some embodiments, said optimization comprises a two-level logic optimization. In some embodiments, said optimization comprises a multi-level logic optimization. In some embodiments, said two-level logic optimization comprises reducing a number of AND and OR gates. In some embodiments, said two-level logic optimization comprises reducing a number of AND, OR, and NOT gates. In some embodiments, at (d) said processor is configured to convert said Boolean circuit into a netlist. In some embodiments, said netlist comprises a directed graph defining a flow and a sequence of logical gates of said Boolean circuit and one or more non-Boolean circuit elements. In some embodiments, said one or more recovery operations are for logical qubits or for physical qubits. In some embodiments, said processor is configured to implement said one or more recovery operations on said logical qubits or said physical qubits.

In some embodiments, said mapping in (b) is based at least in part on a recurrent neural network (RNN). In some embodiments, at (b) said processor is configured to: (i) construct a Deterministic Finite Automaton (DFA) of said RNN; and (ii) construct one or more look up tables based at least in part on a classifier, wherein said classifier is configured to associate a label with each state of said DFA and wherein said classifier comprises a transition function configured to associate each state of said DFA to an input of a state of said DFA. In some embodiments, said RNN comprises a clustering layer for reducing DFA size. In some embodiments, at (i) said processor is configured to: implement a merging procedure in the space of hidden states of said RNN, wherein said merging procedure is configured to reduce the complexity of said DFA. In some embodiments, said processor is configured to: reduce said DFA complexity based at least in part on a Hopcroft algorithm. In some embodiments, said processor is configured to: construct binary state encoding of DFA. In some embodiments, at (d) wherein said processor is configured to: convert said Boolean circuit into a netlist. In some embodiments, said processor is configured to: optimize said netlist at least in part by relabeling said DFA.

In some embodiments, said one or more syndrome measurements are from a quantum error correction code comprising one or more members selected from the group consisting of: a Surface code, a colour code, a toric code, and a Bacon-Shor code. In some embodiments, prior to (a), said processor is configured to: implement a quantum error correction code. In some embodiments, said quantum error correction code comprises one or more members selected from the group consisting of: a Surface code, a colour code, a toric code, and a Bacon-Shor code. In some embodiments, said quantum error correction decoder comprises one or more members selected from the group consisting of: a Minimum-Weight Perfect Matching decoder, a Union Find decoder, a Belief Matching decoder, a Tensor-Network decoder, and a renormalization group decoder.

Additional aspects and advantages of the present disclosure will become readily apparent to those skilled in the art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a diagram of a quantum error correction decoder chip comprising one or more Boolean circuits.

FIG. 2 is a flowchart of an example method for synthesizing Boolean circuits for an error correction decoder.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every subrange and value within the range is present as if explicitly written out. The term “about” or “approximately” may mean within an acceptable error range for the particular value, which will depend in part on how the value is measured or determined, e.g., due to the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

### Classical Computer

In some cases, the systems, media, networks, and methods described herein comprise a classical computer (e.g., a digital computer), or use of the same. In some cases, a classical computer may comprise a digital computer. In some cases, the classical computer includes one or more hardware central processing units (CPUs) that carry out the classical computer's functions. In some cases, the classical computer further comprises an operating system (OS) configured to perform executable instructions. In some cases, the classical computer is connected to a computer network. In some cases, the classical computer is connected to the Internet such that it accesses the World Wide Web. In some cases, the classical computer is connected to a cloud computing infrastructure. In some cases, the classical computer is connected to an intranet. In some cases, the classical computer is connected to a data storage device.

In some cases, the classical computer is connected to a computer network. In some cases, the classical computer is connected to the Internet such that it accesses the World Wide Web. In some cases, the classical computer is connected to one or more computer servers, which can enable distributed computing, such as a cloud computing infrastructure. In some cases, the classical computer is connected to an intranet and/or extranet or an intranet and/or extranet that is in communication with the Internet. In some cases, the classical computer is connected to a data storage device. In some cases, the network is a telecommunication and/or data network. In some cases, the network is a peer-to-peer network, which may enable devices coupled to the computer system to behave as a client or a server.

In accordance with the description herein, suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with methods and systems described herein. Select televisions, video players, and digital music players, in some cases, with computer network connectivity, may be suitable for use in the systems and methods described herein. Suitable tablet computers may include those with booklet, slate, and convertible configurations.

In some cases, the classical computer includes an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux®, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, Apple® macOS®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Microsoft® Xbox 360®, Microsoft® Xbox One®, Nintendo® Wii®, Nintendo® Wii U®, and Ouya®.

In some cases, the classical computer includes a storage and/or memory device. In some cases, the storage and/or memory device is one or more physical apparatuses used to store data or programs on a temporary or permanent basis. In some cases, the storage and/or memory device may have one or more additional data storage units that are external to the classical computer, for example, being located on a remote server that is in communication with the classical computer through an intranet or the Internet. In some cases, the device is volatile memory and requires power to maintain stored information. In some cases, the device is non-volatile memory and retains stored information when the classical computer is not powered. In some cases, the non-volatile memory comprises flash memory. In some cases, the non-volatile memory comprises dynamic random-access memory (DRAM). In some cases, the non-volatile memory comprises ferroelectric random-access memory (FRAM). In some cases, the non-volatile memory comprises phase-change random access memory (PRAM). In some cases, the device is a storage device including, by way of non-limiting examples, CD-ROMs, DVDs, flash memory devices, magnetic disk drives, magnetic tapes drives, optical disk drives, and cloud computing-based storage. In some cases, the storage and/or memory device is a combination of devices such as those disclosed herein.

In some cases, the classical computer includes a display to send visual information to a user. In some cases, the display is a cathode ray tube (CRT). In some cases, the display is a liquid crystal display (LCD). In some cases, the display is a thin film transistor liquid crystal display (TFT-LCD). In some cases, the display is an organic light emitting diode (OLED) display. In some cases, on OLED display is a passive-matrix OLED (PMOLED) or active-matrix OLED (AMOLED) display. In some cases, the display is a plasma display. In some cases, the display is a video projector. In some cases, the display is a combination of devices such as those disclosed herein.

In some cases, the classical computer includes an input device to receive information from a user. In some cases, the input device is a keyboard. In some cases, the input device is a pointing device including, by way of non-limiting examples, a mouse, trackball, track pad, joystick, game controller, or stylus. In some cases, the input device is a touch screen or a multi-touch screen. In some cases, the input device is a microphone to capture voice or other sound input. In some cases, the input device is a video camera or other sensor to capture motion or visual input. In some cases, the input device is a Kinect®, Leap Motion®, or the like. In some cases, the input device is a combination of devices such as those disclosed herein.

### Quantum Device

Any type of quantum computer may be suitable for the technologies disclosed herein. A quantum processor or quantum computer may comprise one or more adiabatic quantum computers, quantum gate arrays, one-way quantum computers, topological quantum computers, quantum Turing machines, superconductor-based quantum computers, trapped ion quantum computers, trapped atom quantum computers, optical lattices, quantum dot computers, spin-based quantum computers, spatial-based quantum computers, Loss-DiVincenzo quantum computers, nuclear magnetic resonance (NMR) based quantum computers, solution-state NMR quantum computers, solid-state NMR quantum computers, solid-state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, nitrogen-vacancy (NV) diamond-based quantum computers, Bose-Einstein condensate-based quantum computers, transistor-based quantum computers, and rare-earth-metal-ion-doped inorganic crystal based quantum computers. The quantum processor or quantum computer may comprise one or more of: quantum annealers, Ising solvers, optical parametric oscillators (OPO), and gate model quantum computers.

A quantum processor or quantum computer may comprise one or more qubits. The one or more qubits may comprise superconducting qubits, trapped ion qubits, trapped atom qubits, photon qubits, quantum dot qubits, electron spin-based qubits, nuclear spin-based qubits, molecular magnet qubits, fullerene-based qubits, diamond-based qubits, nitrogen-vacancy (NV) diamond-based qubits, Bose-Einstein condensate-based qubits, transistor-based qubits, or rare-earth-metal-ion-doped inorganic crystal based qubits.

In accordance with the description herein, suitable quantum computers may include, by way of non-limiting examples including the associated references, each of which are incorporated by reference in their entireties: superconducting quantum computers (qubits implemented as small superconducting circuits-Josephson junctions) (Clarke et al., “Superconducting quantum bits,” Nature 453, no. 7198, pp. 1031-1042, 2008); trapped-ion quantum computers (qubits implemented as states of trapped ions) (Kielpinski et al., “Architecture for a large-scale ion-trap quantum computer,” Nature 417, no. 6890, pp. 709-711, 2002); optical lattice quantum computers (qubits implemented as states of neutral atoms trapped in an optical lattice) (Deutsch et al., “Quantum computing with neutral atoms in an optical lattice,” Fortschritte der Physik: Progress of Physics 48, no. 9-11, pp. 925-943, 2000); spin-based quantum dot computers (qubits implemented as the spin states of trapped electrons) (Imamoğlu et al., “Quantum information processing using quantum dot spins and cavity QED,” Physical Review Letters 83, no. 20, p 4204, 1999); spatial-based quantum dot computers (qubits implemented as electron positions in a double quantum dot) (Fedichkin et al., “Novel coherent quantum bit using spatial quantization levels in semiconductor quantum dot,” arXiv:quant-ph/0006097, 2000); coupled quantum wires (qubits implemented as pairs of quantum wires coupled by quantum point contact) (Bertoni et al., “Quantum logic gates based on coherent electron transport in quantum wires,” Physical Review Letters 84, no. 25, p. 5912, 2000); nuclear magnetic resonance quantum computers (qubits implemented as nuclear spins and probed by radio waves) (Cory et al., “Nuclear magnetic resonance spectroscopy: An experimentally accessible paradigm for quantum computing,” arXiv:quant-ph/9709001, 1997); solid-state NMR Kane quantum computers (qubits implemented as the nuclear spin states of phosphorus donors in silicon) (Kane, “A silicon-based nuclear spin quantum computer,” Nature 393, no. 6681, pp. 133-137, 1998); electrons-on-helium quantum computers (qubits implemented as electron spins) (Lyon, “Spin-based quantum computing using electrons on liquid helium,” arXiv:cond-mat/0301581, 2006); cavity quantum electrodynamics-based quantum computers (qubits implemented as states of trapped atoms coupled to high-finesse cavities) (Burell, “An Introduction to Quantum Computing using Cavity QED concepts,” arXiv:1210.6512, 2012); molecular magnet-based quantum computers (qubits implemented as spin states) (Leuenberger et al., “Quantum Computing in Molecular Magnets,” arXiv:cond-mat/0011415, 2001); fullerene-based electron spin resonance (ESR) quantum computers (qubits implemented as electronic spins of atoms or molecules encased in fullerenes) (Harneit, “Spin Quantum Computing with Endohedral Fullerenes,” arXiv:1708.09298, 2017); linear optical quantum computers (qubits implemented as processing states of different modes of light through linear optical elements such as mirrors, beam splitters and phase shifters) (Knill et al. “Efficient linear optics quantum computation,” arXiv:quant-ph/0006088, 2000); diamond-based quantum computers (qubits implemented as electronic or nuclear spins of nitrogen-vacancy (NV) centres in diamond) (Nizovtsev et al., “A quantum computer based on NV centers in diamond: optically detected nutations of single electron and nuclear spins,” Optics and spectroscopy 99, no. 2, pp. 233-244, 2005); Bose-Einstein condensate-based quantum computers (qubits implemented as two-component Bose-Einstein condensates) (Byrnes et al., “Macroscopic quantum computation using Bose-Einstein condensates,” arXiv:quantum-ph/1103.5512, 2011); transistor-based quantum computers (qubits implemented as semiconductors coupled to nanophotonic cavities) (Sun et al., “A single-photon switch and transistor enabled by a solid-state quantum memory,” arXiv:quant-ph/1805.01964, 2018); rare-earth-metal-ion-doped inorganic crystal-based quantum computers (qubits implemented as atomic ground state hyperfine levels in rare-earth-ion-doped inorganic crystals) (Ohlsson et al. “Quantum computer hardware based on rare-earth-ion-doped inorganic crystals,” Optics Communications 201, no. 1-3, pp. 71-77, 2002); and metal-like carbon nanospheres based quantum computers (qubits implemented as electron spins in conducting carbon nanospheres) (Náfrádi et al., “Room temperature manipulation of long lifetime spins in metallic-like carbon nanospheres,” arXiv:cond-mat/1611.07690, 2016), each of which are incorporated by reference herein in their entireties.

### Quantum Error Correction

Quantum error correction comprises methods for reducing error rates in quantum computations. In some cases, quantum error correction may comprise using a plurality of physical qubits and gates to encode and use one or more resulting logical qubits with lower error rates than those of the constituent physical qubits and gates. At the heart of quantum error correction is a quantum error-correcting code. A quantum error-correcting code may comprise several parameters: the number of data qubits (denoted by n), the number of logical qubits (denoted by k), and the smallest number of errors relating any two code states (called the code distance and denoted by d). The code states may form a distinguished subspace of the full Hilbert space of joint states of the data qubits. Error correction may comprise detecting and correcting errors which move the joint data qubit state out of the code space.

Quantum error-correcting codes are an extension of the classical concept of error correcting codes, which can encode one or more logical bits using many low-fidelity bits by correcting bit-flip errors.

In an example, a class of quantum error-correcting codes is given by stabilizer codes. The stabilizer formalism is as follows. An abelian subgroup K of the n-qubit Pauli group is chosen; this is called the stabilizer subgroup. A set of generators A_1, A_2, . . . , A_k is chosen for K. The code space is the space of states of the data qubits which are stabilized by A, i.e., eigenstates of eigenvalue+1. The code space therefore encodes n-k logical qubits. Simultaneously measuring each of the stabilizers A_1, A_2, . . . , A_k projects the data state to the code space. (For more details, see Gheorghiu, “Standard form of qudit stabilizer groups,” Physics Letters A 378, no. 5-6, pp. 505-5, 2014, and Gottesman, “An introduction to quantum error correction and fault-tolerant quantum computation,” In Quantum information science and its contributions to mathematics, Proceedings of Symposia in Applied Mathematics, 68, pp. 13-58, 2010, which are each incorporated by reference herein in their entireties.)

One of the examples of stabilizer codes are Calderbank-Shor-Steane (CSS) codes. CSS codes are defined using the CSS construction, which produces a single quantum error-correcting code from two nested linear error-correcting codes, C′<C, with the same number of data bits. The logical qubit is encoded within the subquotient C/C′. The reason this construction produces a quantum error-correcting code is that (1) the ability to correct both Pauli X (bit-flip) errors and Pauli Z (phase-flip) errors enables full quantum error correction, and (2) application of the Hadamard gate flips a code to its dual, and interchanges X errors for Z errors. For CSS codes, each stabilizer generator is either of X-type or of Z-type. (For examples, see Chapter 10 of Nielson et al., “Quantum Computation and Quantum Information,” Cambridge University Press, New York, 2000, which is incorporated by reference herein in its entirety.)

In a quantum error-correcting code, a plurality of physical data qubits may be kept in an entangled state. One or multiple logical qubits are represented as certain degrees of freedom within the Hilbert space of the data qubits, while perturbations along the other degrees of freedom may be measured, decoded, and then corrected. In some cases, the measuring, decoding, and correcting may be performed substantially continuously. The degrees of freedom are chosen so that individual, topologically isolated errors in the code can be detected and corrected. Decoding may involve a diagnosis step of inferring which data qubits are likely erroneous based on the measured syndrome history. The process of measuring syndrome qubits, decoding, and then applying a correction may be performed many times within a single quantum circuit, and therefore it may be advantageous for it to be both fast and accurate to minimize the accumulation of errors.

A variable of importance may be the distance of the quantum error-correcting code. The overhead in terms of the number of data qubits used and the time per quantum gate is polynomial in the code distance. But in theory the error rate of the logical components may be exponential in the code distance, provided that the physical components' error rate is smaller than a fixed threshold value. Thus, by creating codes with a large code distance, lower logical error rates may be achieved. However, the decoding step may grow in difficulty as the code distance increases, and this may present a barrier to creating codes with a large distance. To make use of larger code distances, the decoder may detect strings of errors of a length up to half the code distance, which might occur. The algorithms used to do this may be complex. For example, the size and amount of training data used to create a successful neural network-based decoder may be prohibitive for large code distances.

In some examples, quantum error correction proceeds as follows. At regular time intervals, syndrome extraction circuits comprising data qubits and syndrome qubits are executed. Such a syndrome extraction circuit may comprise a sequence of physical qubit gates followed by a measurement which produces readouts from the syndrome qubits, and, in the absence of substantial errors, provides the result of the measurement to the corresponding stabilizer. This collection of readouts may be referred to as a syndrome. This process may be repeated several times to produce a syndrome history. This syndrome history may provide incomplete information about the error which has occurred and may be sent to the classical decoder which may infer the most likely error which may be afflicting the data qubits. The decoder may return a candidate recovery operation, which is then either applied to the data qubits or is stored. Various classical algorithms have been developed to perform efficient and accurate decoding, depending on the code used. (More details can be found in Chamberland et al., “Triangular color codes on trivalent graphs with flag qubits,” New Journal of Physics 22, no. 2, p. 023019, 2020; Kubica et al., “Efficient color code decoders in d≥2 dimensions from toric code decoders,” arXiv:1905.07393, 2019; and Delfosse et al., “Almost-linear time decoding algorithm for topological codes,” arXiv:1709.06218, 2017, each of which is incorporated herein by reference in its entirety).

Error correction in quantum computers may be useful in order to provide fault tolerant quantum computations and to perform large-scale quantum algorithms for solving computational problems which may be intractable for classical computers.

A physical quantum device, such as a qubit in a quantum computer, may suffer from continuous errors as a result of various sources, such as natural decoherence or an interaction with a control apparatus. One approach to overcoming these errors is by using quantum error correction schemes, where a single logical qubit is encoded using a combination of (1) a number of physical qubits for performing the quantum computations, (2) additional syndromes qubits and error correction circuitry to detect errors in the quantum states of physical qubits performing the quantum computations, (3) a decoder which prescribes recovery operations on the basis of observed syndromes, (4) a controller to apply the recovery operations to the physical qubits, and sub-combinations thereof. Fault-tolerance may be achieved when errors can be detected and corrected at a faster rate than they accrue, thereby preventing errors from compounding over long computations.

However, engineering such a quantum error correction system presents challenges. The complexity increases exponentially with the increasing number of error possibilities to be corrected. It may be useful for decoding to be done in a short period of time to enable actions used to correct errors. Performing decoding quickly in a decoder and locating the decoder as close to qubits as possible can reduce latency caused by error correction operations. The decoding process can be implemented by a classical co-processor that is located adjacent to the quantum processor formed by qubits, and to perform the decoding process on the same timeframe as the rate at which errors are generated. For superconducting qubits, which may have very short decoherence times and very fast gates, this fast-decoding time can be difficult or challenging to achieve because of (1) the latency time required to transmit readout information between the quantum processor and classical co-processor, and (2) the processing time required to perform the decoding.

Recognized herein is the need for improved methods and systems that may overcome at least one of the above-identified drawbacks.

The technology disclosed in this patent document can be implemented in ways to provide a method and a system to mitigate certain limitations associated with the accuracy of physical qubits, the communication lag between a quantum processor and classical co-processor and the speed limitation of error-correction.

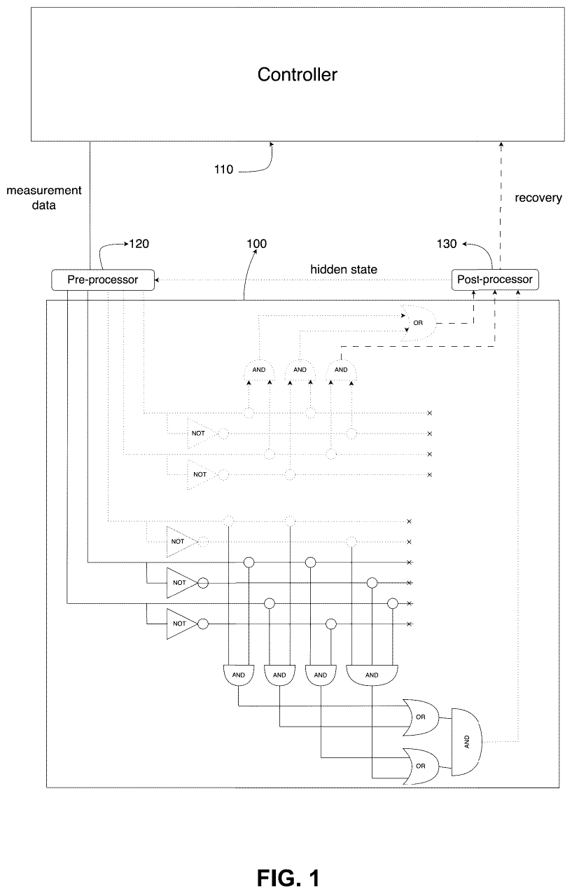

Now referring to FIG. 1, there is shown a diagram of a quantum error correction decoder chip comprising one or more Boolean circuits 100. The one or more Boolean circuits 100 may be of various types. The one or more Boolean circuits 100 may comprise at least one member of the group consisting of: a field programmable gate array (FPGA), ASICS, CMOS, and SFQ. The one or more Boolean circuits 100 is for receiving one or more input binary variables derived from one or more syndrome measurements from syndrome qubits, and for processing said one or more input binary variables to generate output binary variables to be used for generating one or more recovery operation. The recovery operation may be of various types. In some cases, the recovery operation comprises updating the Pauli frame or updating data qubits to reduce errors in quantum computing. The binary variables may be derived from one or more syndrome measurements by a pre-processor 120. The one or more recovery operations may be generated using output binary variables by a post-processor 130. The pre-processor 120 may be of various types. In some cases, the pre-processor 120 comprises a timing module synchronizing the reception of its inputs before they are delivered to the one or more Boolean circuit 100. In some cases, the pre-processor 120 comprises a module that takes a logical difference of the current measured data vector with the previous vector. The post-processor 130 may be of various types. In some cases, the post-processor 130 comprises a dispatching module that decides whether a recovery operation is output in a given measurement round.

The quantum error correction decoder chip may be coupled to a quantum processor not shown in the diagram. The quantum processor may be of various types. The quantum processor may be any quantum processor disclosed elsewhere herein with respect to quantum devices. The quantum processor may be coupled to and cooled by a cryogenic device at a cryogenic temperature. The cryogenic device is not shown in the diagram. In some cases, the cryogenic device has different cryogenic stages at different cryogenic temperatures. The one or more Boolean circuits may be coupled to and cooled by the cryogenic device at a different cryogenic stage. The cryogenic stages are capable of efficiently dissipating varying levels of heat, and hence support various levels of complexity of the Boolean circuit implementing the decoder mapping. In some cases, the one or more Boolean circuits may be kept in the cryogenic device at a cryogenic temperature higher than that of the quantum processor 1210 such as 100 mK, 600 mK, 3K or 4K. In some cases, the one or more Boolean circuits may be kept in the cryogenic device at the same cryogenic stage as the quantum processor and at the same cryogenic temperature (e.g., tens of mK).

The cryogenic device may be of various types. In some cases, the cryogenic device includes a cryogenic platform capable of reaching the required low temperature for operation of qubits. In some cases, the cryogenic device includes a dilution refrigerator system with different cryogenic stages at different temperatures. In some cases, the cryogenic device includes a cryocooler system. In other cases, the cryogenic device includes an adiabatic demagnetization refrigerator.

The one or more Boolean circuits 100 may be coupled to a circuit cooled by the cryogenic device. The one or more Boolean circuits 100 may be coupled to a circuit being at room temperature.

In some cases, the quantum error correction decoder chip is coupled to a controller 110. The controller 110 may be of various types.

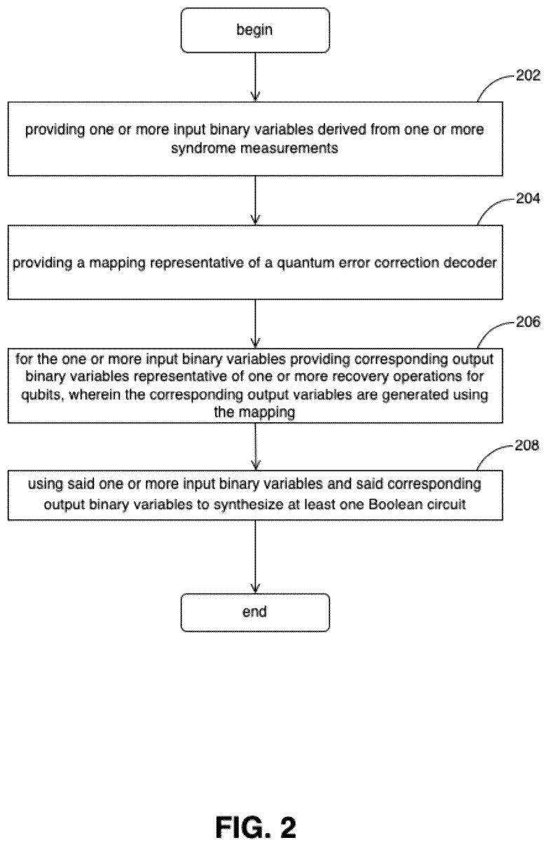

Now referring to FIG. 2, there is shown a flowchart of an example method for synthesizing Boolean circuits for a quantum error correction decoder. The error correction decoder may be of various types. In some cases, the error correction decoder comprises at least one member of the group consisting of: a Minimum-Weight Perfect Matching decoder, a Union Find decoder, a Belief Matching decoder, a Tensor-Network decoder, and a renormalization group decoder.

According to processing operation 202, one or more input binary variables derived from one or more syndrome measurements are provided. The one or more syndrome measurements may be provided using various types of quantum error correction code. The one or more syndrome measurements may be provided from a quantum error correction code comprising one or more members of the group consisting of: a Surface code, a colour code, a toric code, and a Bacon-Shor code.

According to processing operation 204, a mapping representative of the quantum error correction decoder is provided. The mapping representative of the quantum error correction decoder may be of various types. In some case, the mapping of the quantum error correction decoder is based on a recurrent neural network (RNN). The quantum error correction decoder may implement a mapping, d:{0,1}^{N}^{ₛ}→{0,1}^{N}^{_{c}} where the input space is associated with the syndrome measurements and the output space represents a recovery operation. For example, when N_{c}=2 the recovery operation can be interpreted as a logical X and Z corrections on the encoded logical qubit. In some cases, N_{c} corresponds to the number of data qubits, and the recovery operation may represent X or Z error corrections on the data qubits. In some cases, the mapping representative of a quantum error correction decoder is a lookup table or a neural network. The look up table may encode a mapping between Boolean input and output strings. The look up table may also include “don't care” terms which are bitstrings for which the output does not matter. The look up table may also include “don't happen” terms which are bitstrings that are known to never occur.

In some cases, the mapping representative of a quantum error correction decoder d:{0,1}^{N}^{ₛ}×{0,1}^{N}^{ₛ}×{0,1}^{N}^{ₛ}× . . . →{0,1}^{N}^{_{c}}×{0,1}^{N}^{_{c}}×{0,1}^{N}^{_{c}}× . . . may be sequential. In some case, the mapping representative of the quantum error correction decoder may be based on a recurrent neural network (RNN). In some cases, the RNN may be defined via functions f(h, x) and g(h) wherein h and x are vectors associated with the hidden and input states accordingly. To simplify the presentation of the disclosed method and without limitation, it is assumed N_{c}=1. The method generalizes to dimensions N_{c}≥2. In some cases, a Deterministic Finite Automaton (DFA) may be constructed to approximate the computation performed by the RNN. The Deterministic Finite Automaton (DFA) of the RNN may be constructed in order to construct one or more look up tables based on a classifier associating a label with each state of the DFA and based on transition function associating each state of said DFA to a joint input consisting of a state of said DFA and binary variables associated with the syndrome measurements. In some cases, binary state encoding of DFA is constructed. In some cases, the RNN may comprise a clustering layer for reducing DFA size. In some cases, an RNN with a clustering layer may be trained to facilitate the DFA extraction step after the training is done. In some cases, the clustering layer may be used, as proposed by Das and Mozer in “A Unified Gradient-Descent/Clustering Architecture for Finite State Machine Induction,” in Proceedings of NIPS 1993, Vol. 6, which is incorporated by reference herein in its entirety.

The extracted DFA may be defined by a tuple <Σ, Q, q₀, δ, F>. Herein, Σ is the finite input alphabet and is a subset of admissible input values to the RNN that is contained in the set {0,1}^{N}^{ₛ}. Q is the set of states that DFA can transition to with q₀ being its initial state. δ: Q×Σ→Q is a transition function that transitions the DFA from one state to another in response to a new input letter in Σ. F is a classifier which associates with each state a label interpreted as the output of the decoder.

In some cases, the constructing of the DFA may comprise a merging procedure in the space of hidden states of the RNN. In some cases, the merging procedure may reduce the complexity of the DFA. The DFA may be extracted from RNN according to the procedure described by Merrill and Tsilivis in “Extracting Finite Automata from RNNs Using State Merging,” arXiv:2201.12451, which is incorporated herein by reference in its entirety. For the purpose of illustration and without limitation, each new RNN input bit-string may be interpreted as a letter accepted by the DFA; a prefix may be a full or partial sequence of letters that includes the first letter; and a word generally refers to full sequences of letters.

An uncompressed DFA also referred to as the prefix tree may be constructed from the subset of words in the RNN's training set. In an example, each word may be read out sequentially letter-by-letter into a prefix and for each new prefix a new DFA state may be introduced. Transitions between FDA states store an associated letter and in response to a new letter may be recorded. Each arrow may be associated with the letter it is created for. Moreover, with each DFA state, the information related to the RNN's hidden state h obtained by feeding in the same prefix as well as the label g(h) are associated. In some cases, the information related to the RNN's hidden state h is the vector h itself. The information associated with the hidden RNN state may be used to evaluate the distance between pairs of DFA states. In some cases, the distance may be evaluated using the cosine similarity between h₁ and h₂. This pair of states may be merged if the distance value is smaller than the value of a hyper-parameter K or if the labels g(h₁) and g(h₂) are the same. To perform the state merge, the states in the pair from the DFA may be removed. Instead, a new single state may be added to the DFA which inherits at least some or all incident and outgoing arrows from the deleted states. The new state may be associated with the information derived from the information attached to the merged states. In some cases, this information comprises the label g(h₁) as well as the vector h₁. Subsequent to the merging process, a Non-deterministic Finite Automaton (NFA) may be obtained. The NFA may then be converted to a new DFA, for example, using the powerset construction. The size of the resulting DFA may be minimized. In some cases, the constructing of the DFA may comprise using the Hopcroft algorithm to reduce said DFA complexity. The minimization may be performed according to the procedure described in Hopcroft, “An n log n algorithm for minimizing states in a finite automaton,” Theory of Machines and Computations, pp. 189-196, Elsevier, 1971, which is incorporated herein by reference in its entirety.

According to processing operation 206, for the one or more input binary variables corresponding output binary variables representative of one or more recovery operations for qubits are provided. The output binary variables are generated using the mapping representative of the quantum error correction decoder. The one or more recovery operations may be for logical qubits or for physical qubits.

The quantum error correction decoder may implement a mapping, d:{0,1}^{N}^{ₛ}→{0,1}^{N}^{_{c}} where the input space is associated with the syndrome measurements and the output space represents a recovery operation. For example, when N_{c}=2 the recovery operation can be interpreted as a logical X and Z corrections on the encoded logical qubit. In some cases, N_{c} corresponds to the number of data qubits, and the recovery operation may represent X or Z error corrections on the data qubits. In some cases, the mapping representative of a quantum error correction decoder is a lookup table or a neural network. The look up table may encode a mapping between Boolean input and output strings. The look up table may also include “don't care” terms which are bitstrings for which the output does not matter. The look up table may also include “don't happen” terms which are bitstrings that are known to never occur.

In some cases, the quantum error correction decoder's input may be endowed with a sequential structure, d:{0,1}^{N}^{ₛ}×{0,1}^{N}^{ₛ}×{0,1}^{N}^{ₛ}× . . . →{0,1}^{N}^{_{c}}×{0,1}^{N}^{_{c}}×{0,1}^{N}^{_{c}} . . . , wherein it is assumed that the number of input and output vectors is the same. Moreover, in order to retrieve the k'th output vector, other inputs than k inputs may not be used. Such sequential structure may be used for decoders applied to repeated rounds of syndrome measurements. To simplify the presentation of the disclosed method and without limitation, it is assumed that N_{c}=1. The disclosed method generalizes to dimensions N_{c}≥2.

Still referring to FIG. 2 and according to processing operation 208, at least one Boolean circuit is synthesized using the one or more input binary variables and the corresponding output binary variables. In some cases, synthesizing the at least one Boolean circuit comprises using the one or more input binary variables and the corresponding output binary variables to construct look up table of the mapping representative of the quantum error correction decoder.

The disclosed methods and systems may aim to reduce the complexity of the synthesized Boolean circuit. The disclosed methods and systems may use the simplification of the original problem of minimal Boolean circuit implementation for the decoder d by noting that different input bit-strings can be associated with different probabilities. Therefore, in practice, it may be sufficient to generate a Boolean circuit for an approximate version of the decoder that differs from the decoder d on a set of bit strings having a small cumulative probability. In some cases, small probability bit-strings may be identified by their hamming distance from all zero bit-strings. The look up table for the approximate decoder may be derived from the look up table for the original decoder by inhering the output values for a set of important bit-strings and marking the rest of bit-strings, for which the exact value of the output is less important, as “don't care” terms.

A Boolean circuit representative of a look up table may be synthesized in various ways. In some cases, the Boolean circuit representative of a look up table is synthesized using the following procedure. Each input bit-string yielding a non-zero output may be encoded as a minterm. A minterm may be a logical conjunctive expression that evaluates to 1 only for the associated bit-string. For example, the minterm for bit-string 1001 is AB′C′D where apostrophes, such as in B′, represent a negation and the products, such as AB, represent two-input AND operations. The sum, performed via OR operation, of all the minterms provides a representative Boolean circuit of the said look up table. Such representation is referred to as a sum-of-products (SOP) expression.

The SOP representation of input/output in the look up table may be compressed using two-level logic optimization. Such optimization may take into account don't care and don't happen terms in the look up table in order to reduce the complexity of the SOP representation of the look up table.

In some cases, synthesizing the at least one Boolean circuit comprises performing an optimization on the Boolean circuit to reduce the number of the logical gates, such as AND, OR and NOT logical gates. In some cases, the Boolean circuit is iteratively optimized to reduce the number of logical gates until a threshold condition is met. The threshold condition may be a number of iterations, a threshold in the amount that the number is reduced, or another convergence condition. In some cases, the at least one Boolean circuit is synthesized while minimizing or reducing a figure-of-merit other than the number of AND and OR gates. In some cases, the figure-of-merit may be defined on a netlist derived from the Boolean circuit containing AND, OR and NOT logical gates. Such a netlist may comprise a directed graph defining flow and sequence of the Boolean circuit logical gates and one or more non-Boolean circuit elements. In some cases, the netlist may comprise other primitive gates such as XOR logical gate as well as non-logic gates such as SPLITTER. The figure-of-merit may relate to physical resources required for a physical implementation of the netlist. In some cases, the figure of merit may include the depth of the netlist, the number of required transistors (in CMOS implementation) or Josephson junctions (in SFQ implementation).

In some cases, the Quine-McCluskey algorithm in conjunction with the Petrick's method may be used to perform a two-level logic optimization to minimize the SOP expression with respect to the total number of two-input AND and OR gates. The minimized SOP expression may remain functionally equivalent to the original SOP expression. In some other cases, a heuristic Espresso algorithm may be used to perform this minimization with an advantage of being able to scale to larger input dimensions Nₛ. Both Quine-McCluskey and Espresso algorithms generalize to the setting of the approximate decoder. The SOP expression may be converted to a gate level netlist that may be further adapted to the underlying technological implementation before proceeding with the next steps of integrated circuit generation. For example, electronic technologies restricted to two-input gates may require converting multi-input minterms to a hierarchical sequence of two-level gates.

In some cases, hardware resources used to implement the Boolean circuit associated with the two-level representation for the look up table representative of the decoder d may be further improved by performing a multi-level logic synthesis and optimization. One source for a possibility for such improvement may be based on the observation that different minterms in the two-level representation may share the same subexpressions. Therefore, by factoring out such subexpressions, the number of logic operations used to implement the look up table may be reduced. Additionally, these subexpressions may be evaluated before the rest of the circuit which may lead to an increased depth of the associated Boolean circuit. In some cases, software packages such as ABC may be used to facilitate this process. A non-limiting example of ABC may be found at: Berkeley Logic Synthesis and Verification Group “A System for Sequential Synthesis and Verification,” available at https://people.eecs.berkeley.edu/˜alanmi/abc/, which is incorporated by reference herein in its entirety. Moreover, ABC contains further heuristics that when applied iteratively may lead to further circuit minimization. As a step in this process, ABC may translate sub-circuits that can be expressed using a set of user-defined gates (such as 2-input AND, XOR), convert the resulting Boolean circuit into a netlist and directly optimize over a figure-of-merit over the resulting netlist.

In some cases, the mapping representative of a quantum error correction decoder d:{0,1}^{N}^{ₛ}×{0,1}^{N}^{ₛ}×{0,1}^{N}^{ₛ}× . . . →{0,1}^{N}^{_{c}}×{0,1}^{N}^{_{c}}×{0,1}^{N}^{_{c}}× . . . may be sequential. In some case, the mapping representative of the quantum error correction decoder may be based on a recurrent neural network (RNN). In some cases, the RNN may be defined via functions f(h, x) and g(h) wherein h and x are vectors associated with the hidden and input states accordingly. To simplify the presentation of the disclosed method and without limitation, it is assumed N_{c}=1. The method generalizes to dimensions N_{c}≥2. In some cases, a Deterministic Finite Automaton (DFA) may be constructed to approximate the computation performed by the RNN. The Deterministic Finite Automaton (DFA) of the RNN may be constructed in order to construct one or more look up tables based on a classifier associating a label with each state of the DFA, and based on transition function associating each state of said DFA to a joint input comprising a state of said DFA and binary variables associated with the syndrome measurements. In some cases, binary state encoding of DFA is constructed. In some cases, the RNN may comprise a clustering layer for reducing DFA size. In some cases, an RNN with a clustering layer may be trained to facilitate the DFA extraction step after the training is done. In some cases, the clustering layer may be used, as proposed by Das and Mozer in “A Unified Gradient-Descent/Clustering Architecture for Finite State Machine Induction,” in Proceedings of NIPS 1993, Vol. 6, which is incorporated by reference herein in its entirety.

The extracted DFA may be defined by a tuple <Σ, Q, q₀, δ, F>. Herein, Σ is the finite input alphabet and is a subset of admissible input values to the RNN that is contained in the set {0,1}^{N}^{ₛ}. Q is the set of states that DFA can transition to with q₀ being its initial state. δ:Q×Σ→Q is a transition function that transitions the DFA from one state to another in response to a new input letter in E. F is a classifier which associates with each state a label interpreted as the output of the decoder.

In some cases, the constructing of the DFA may comprise a merging procedure in the space of hidden states of the RNN. In some cases, the merging procedure may reduce the complexity of the DFA. The DFA may be extracted from RNN according to the procedure described by Merrill and Tsilivis in “Extracting Finite Automata from RNNs Using State Merging,” arXiv:2201.12451, which is incorporated by reference herein in its entirety. For the purpose of illustration and without limitation, each new RNN input bit-string may be interpreted as a letter accepted by the DFA; a prefix may be a full or partial sequence of letters that includes the first letter; and a word generally refers to a full sequences of letters.

An uncompressed DFA also referred to as the prefix tree may be constructed from the subset of words in the RNN's training set. In an example, each word may be read out sequentially letter-by-letter into a prefix and for each new prefix a new DFA state may be introduced. Transitions between FDA states in response to a new letter may be recorded and store an associated letter. Each arrow may be associated with the letter it is created for. Moreover, with each DFA state, the information related to the RNN's hidden state h obtained by feeding in the same prefix as well as the label g(h) are associated. In some cases, the information related to the RNN's hidden state h is the vector h itself. The information associated with the hidden RNN state may be used to evaluate the distance between pairs of DFA states. In some cases, the distance may be evaluated using the cosine similarity between h₁ and h₂. This pair of states may be merged if the distance value is smaller than the value of a hyper-parameter K or if the labels g(h₁) and g(h₂) are the same. To perform the state merge, the states in the pair from the DFA may be removed. Instead, a new single state may be added to the DFA which inherits all incident and outgoing arrows from the deleted states. The new state may be associated with the information derived from the information attached to the merged states. In some cases, this information comprises the label g(h₁) as well as the vector h₁. At the end of the merging process, a Non-deterministic Finite Automaton (NFA) may be obtained. The NFA may then be converted to a new DFA, for example, using the powerset construction. The size of the resulting DFA may be minimized. In some cases, the constructing of the DFA may comprise using the Hopcroft algorithm to reduce said DFA complexity. The minimization may be performed according to the procedure described in Hopcroft, “An n log n algorithm for minimizing states in a finite automaton,” in Theory of Machines and Computations, pp. 189-196, Elsevier, 1971, which is incorporated by reference herein in its entirety.

In some cases, synthesizing the at least one Boolean circuit may comprise converting the Boolean circuit into a netlist and optimizing the netlist by relabeling the DFA. In some cases, the labeling of DFA states Q may be binarized. For example, if Q contains three states {q₀, q₁, q₂}, they may be labeled as {00, 01, 10}. For simplicity of presentation and without limitation, it is assumed that N_{b} bits are required for the encoding. A particular choice of the state binary encoding strategy may have an effect on the figure-of-merit evaluated on the resulting netlist. In some cases, a binary state encoding that attempts to preserve the distance relationships between pairs of binary encodings and their corresponding RNN states may be chosen. In an example, the distance between binary encodings can be their Hamming distance and the distance between the RNN states can be their cosine similarity. In some cases, a heuristic discrete optimization algorithm may be used to optimize the binary state encoding as quantified by the evaluation of the figure-of-merit on the resulting netlists extracted from the DFA transition δ and classifier F functions.

A binary look-up table δ^{b}:{0,1}^{{N}^{_{b}}^{+N}^{_{s}}}→{0,1}^{{N}^{_{b}}} may be constructed from the transition function δ. The inputs to δ^{b} are binarized states in Q concatenated with the alphabet Σ that have been assumed to be in a binary form from the start. The corresponding outputs of δ^{b} are the binarized states Q determined by δ. Additionally, binary strings excluded from this input space may be marked as “don't care terms.” Similarly to the introduced approximate decoder strategy aiming to reduce the task of Boolean circuit synthesis and minimization, δ^{b} may be further simplified by marking input strings corresponding to low-probability letters as “don't care terms”.

A binary look-up table F^{b}:{0,1}^{{N}^{_{b}}^{}}→{0,1}^{{N}^{_{c}}^{}} may be constructed from the labels F. The inputs to δ^{b} are binarized states in Q. The corresponding outputs are their associated labels F. Additionally, binary strings excluded from this input space are marked as “don't care terms”.

Boolean circuits for both δ^{b} and F^{b} are generated using two-level or multi-level circuit synthesis and minimization described elsewhere herein.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for synthesizing Boolean circuits for a quantum error correction decoder, the method comprising:
(a) providing one or more input binary variables derived at least in part from one or more syndrome measurements;
(b) providing a mapping representative of said quantum error correction decoder;
(c) generating, based at least in part on said mapping, one or more output binary variables corresponding to said one or more input binary variables, wherein said one or more output binary variables are representative of one or more recovery operations for a plurality of qubits; and
(d) synthesizing at least one Boolean circuit based at least in part on said one or more input binary variables and said one or more output binary variables.

2. The method of claim 1, wherein (d) comprises at least one of (i) constructing a look up table of said mapping based at least in part on said one or more input binary variables and said one or more output binary variables, or (ii) performing an optimization on said at least one Boolean circuit to reduce a number of logical gates of said at least one Boolean circuit.

3. The method of claim 2, wherein said optimization is performed iteratively and until a stopping criterion is reached.

4. The method of claim 2, wherein said optimization comprises a multi-level logic optimization.

5. The method of claim 4, wherein said multi-level logic optimization comprises a two-level logic optimization comprising reducing(i) a number of AND and OR gates; or (ii) a number of AND, OR, and NOT gates.

6. The method of claim 1, wherein (d) further comprises converting said at least one Boolean circuit into a netlist and wherein said netlist comprises a directed graph, wherein said directed graph is configured to define a flow and a sequence of logical gates of said at least one Boolean circuit and one or more non-Boolean circuit elements.

7. The method of claim 1, wherein said at least one Boolean circuit is configured to provide said one or more recovery operations, and further comprising implementing said one or more recovery operations on at least one of logical qubits or physical qubits.

8. The method of claim 1, wherein said mapping in (b) is based at least in part on a recurrent neural network (RNN), and wherein (b) further comprises (i) constructing a Deterministic Finite Automaton (DFA) of said RNN, wherein said constructing comprises implementing a merging procedure in a space of hidden states of said RNN, wherein said merging procedure is configured to reduce a complexity of said DFA, and (ii) constructing one or more look up tables based at least in part on a classifier, wherein said classifier is configured to associate a label with each state of said DFA and wherein said classifier comprises a transition function configured to associate each state of said DFA to an input of a state of said DFA.

9. The method of claim 8, wherein said RNN comprises a clustering layer for reducing DFA size.

10. The method of claim 8, further comprising reducing said complexity of said DFA based at least in part on one or more of a Hopcroft algorithm, or constructing a binary state encoding of said DFA.

11. The method of claim 1, wherein said one or more syndrome measurements are from a quantum error correction code comprising one or more members selected from the group consisting of a Surface code, a colour code, a toric code, and a Bacon-Shor code.

12. The method of claim 1, further comprising, prior to (a), implementing a quantum error correction code.

13. The method of claim 1, wherein said quantum error correction decoder comprises one or more members selected from the group consisting of a Minimum-Weight Perfect Matching decoder, a Union Find decoder, a Belief Matching decoder, a Tensor-Network decoder, and a renormalization group decoder.

14. A quantum error correction decoder chip, the chip comprising:
one or more Boolean circuits, wherein said one or more Boolean circuits are configured to receive one or more input binary variables derived from one or more syndrome measurements from syndrome qubits, wherein said one or more Boolean circuits are configured to process said one or more input binary variables to generate one or more output binary variables, and wherein said one or more output binary variables are operable to generate one or more recovery operations.

15. The chip of claim 14, wherein said one or more Boolean circuits comprise at least one member of the group consisting of a field programmable gate array (FPGA), an ASIC, a CMOS, and an SFQ.

16. The chip of claim 14, further comprising a quantum processor and a cryogenic device, wherein said cryogenic device comprises two or more cryogenic stages, wherein said chip is communicatively coupled to said quantum processor, wherein said quantum processor is operably coupled to and cooled by said cryogenic device at a first cryogenic stage comprising first cryogenic temperature, and wherein said one or more Boolean circuits are operatively coupled to and cooled by said cryogenic device at a second cryogenic stage comprising a second cryogenic temperature.

17. The chip of claim 16, wherein said one or more Boolean circuits are operably coupled to one or more of a circuit at room temperature or a circuit cooled by said cryogenic device.

18. The chip of claim 14, wherein said recovery operation comprises one or more of updating a Pauli frame or updating data qubits to reduce errors in quantum computing.

19. The chip of claim 16, wherein said quantum processor comprises one or more members selected from the group consisting of a superconducting quantum processor, a semiconductor quantum processor, a trapped ion quantum processor, and a neutral atom quantum processor.

20. A processor communicatively coupled to a quantum computer, wherein said processor is configured to implement a set of instructions to:
(a) provide one or more input binary variables derived at least in part from one or more syndrome measurements from said quantum computer;
(b) provide a mapping representative of a quantum error correction decoder;
(c) generate, based at least in part on said mapping, one or more output binary variables corresponding to said one or more input binary variables, wherein said one or more output binary variables are representative of one or more recovery operations for a plurality of qubits; and
(d) synthesize at least one Boolean circuit based at least in part on said one or more input binary variables and said one or more output binary variables.
